(19) United States
(12) Patent Application Publication
(10) Pub. No.: US 2020/0155979 A1
(43) Pub. Date: May 21, 2020

(54) FILTERING DEVICE FOR REMOVING SOLIDS FROM WATER

(71) Applicant: Gurtler Industries, Inc., South Holland, IL (US)

(72) Inventor: David Proudman, Crown Point, IN (US)

(21) Appl. No.: 16/195,055

(22) Filed: Nov. 19, 2018

(51) Int. Cl. B01D 29/64; B01D 29/56; B01D 29/90; C02F 1/00

(52) U.S. Cl. CPC B01D 29/6415; B01D 29/56; C02F 2307/12; C02F 1/001; C02F 2303/16; B01D 29/902

(57) ABSTRACT

A filtering device for removing solids from water. Within the filtering device, water, under the force of gravity, flows through successive porous members. Plates are used to distribute the water prior to the water flowing through the porous members. Rotating brushes are used to removed retained solids from the porous members. The brushes are preferably returned to a home position when not being utilized to remove solids in which they are maintained out of contact with the porous members.

### BACKGROUND OF THE INVENTION

The present invention relates to a filtering device, and more particularly to a filtering device for removing solids from water.

Various industries use water for rinsing and cleaning objects in which the water, after rinsing, includes solids material. For various economic and environmental reasons, it is often desirable to re-use the water. Therefore, it is equally desirable to effectively and efficiently remove the solids from the water, so it can be re-used. One such exemplary use and re-use of water is with continuous batch washers, i.e., tunnel washers.

As is known, in a tunnel washer, soiled items to be laundered are continuously passed through a series of sections or zones. The zones can be, for example, pretreatment, rinsing, washing, bleaching or other zones. Water is used in the various zones, and due to its use, the used water often has an increased solids content as a result of the materials removed from the soiled items, such as hair, lint and other solids debris. In order to remove the solids from the water so that the water is cleaned for re-use, a filtering device may be used. The filtering devices may include porous elements to retain the solid materials from the water.

Some current filtering devices allow some water to overflow into a cascading filter or mesh netting and into a holding tank. The water that does not pass through the filter merely flows into the holding tank. A float switch turns on a pump when the water level in the holding tank reaches a certain level, and the water in the holding tank is pumped back to the tunnel washer. While presumably effective for its intended purpose, not all the water is filtered in such a design—only the water that overflows into and through the filter. Additionally, since there is no way to clean it, the filter usually has a large pore size, permitting a significant amount of solid debris to be returned to the tunnel washer.

Moreover, some current filtering devices utilize a closed system in which water is pumped out of the tunnel washer, through a porous member, and back into the tunnel washer. When a certain pressure level has been reached, the porous member is back-washed to remove the retained debris that is clogging the pores of the porous member. This removed debris is typically pumped through a bag filter to collect the debris for disposal. Once the bag filter is full of debris, the bag will require replacement. Additionally, while the filtering device is back-washing the porous member, the filtering device is not able to filter any water from the tunnel.

Another drawback of a system using pressure to force water through a filter, is that to address the clogged pores, the system will either need to be backwashed more frequently or use a higher mesh on the filter allowing more solids to be returned back to the tunnel. Neither of these solutions is desirable.

As would be appreciated, over time, the pores of the porous elements are likely to become clogged with the solid material. Some filtering devices require a shutdown to clean the porous elements. However, in a continuous batch process, it is desirable to minimize, or even eliminate, the need for shutdowns, allowing the tunnel washer and filtering device to continually operate.

While the existing and conventional devices presumably achieve their intended purposes, there is an ongoing desire for a filtering device that does not suffer from these drawbacks.

### SUMMARY OF THE INVENTION

The present invention is directed towards addressing at least some of these drawbacks of the existing filtering devices. Specifically, the present invention provides a new filtering device which removes solids from soiled water, such as removing hair, lint, and other debris from soiled water from a continuous batch laundry washer (“tunnel”). By removing the solids material from the reused water, the laundry downstream in the tunnel is cleaner. The filtering device removes water from a zone of the tunnel, removes debris from the water, and then discharges the clean water back to the tunnel washer, preferably in the same zone. However, the use with a tunnel is merely exemplary and it is contemplated that the present invention be used in many other industries in which solids are removed from water.

According to a first aspect of the present invention, the present invention provides a filtering device with: an inlet configured to receive soiled water comprising solids; an outlet configured to provide cleaned water, the clean water having a reduced amount of solids compared with the soiled water; a first plate configured to receive soiled water from the inlet and allow the solid water to disperse over a surface of the first plate; a first porous member comprising a plurality of openings for retaining solids from the soiled water to provide an intermediate water; a second plate configured to receive intermediate water and allow the intermediate water to disperse over a surface of the second plate; a second porous member comprising a plurality of openings for retaining solids from the intermediate water to provide the cleaned water; a first rotating brush configured to remove solids retained by the first porous member; and, a second rotating brush configured to remove solids retained by the second porous member.

It is contemplated that at least one of the first or second rotating brushes may include two or more brushes. For example, both the first and second rotating brushes may include two brushes.

It is further contemplated that an average size of the openings on the first porous member is greater than an average size of the openings of the second porous member.

It is also contemplated that at least one of the first and second porous members is supported by a third porous member.

It is still further contemplated that at least one of the first and second rotating brushes is configured to return to a home position in which the at least one of the first and second rotating brushes is not maintained in contact with the first or second porous member.

It is contemplated that the filtering device includes a reservoir configured to collect the cleaned water from the second porous member.

It is contemplated that the filtering device also includes a first tray configured to collect debris removed from the first porous member by the first rotating brush and, a second tray configured to collect debris removed from the second porous member by the second rotating brush.

According to at least one aspect, water flows from the first plate, through the first porous member, to the second plate and from the second plate through the second porous member by gravity.

It is still further contemplated that the at least one of the first and second rotating brushes has an adjustable height.

In a second aspect, the present invention may be broadly characterized as providing a filtering device configured to remove solid from soiled water, the filtering device including: a first catch plate configured to disperse water over the surface of the first catch plate before flowing over an edge of the first catch plate; a second catch plate configured to disperse water over the surface of the second catch plate before flowing over an edge of the second catch plate; a reservoir configured to collect water; a first porous member disposed between the first catch plate and the second catch plate, the first porous member comprising a plurality of openings for retaining solids; a second porous member disposed between the second catch plate and the reservoir, the second porous member comprising a plurality of openings for retaining solids; a first rotating brush configured to remove solids retained by the first porous member; and, a second rotating brush configured to remove solids retained by the second porous member.

It is contemplated that water flows from the first catch plate, through the first porous member, to the second catch plate by gravity.

It is also contemplated that the first and second rotating brushes each comprises two brushes. Additionally, an average size of the openings on the first porous member may be greater than an average size of the openings of the second porous member.

The filtering device may further include a first tray configured to collect debris removed from the first porous member by the first rotating brush, and a second tray configured to collect debris removed from the second porous member by the second rotating brush.

The filtering device may also include a controller in communication with a first motor operatively coupled to a first shaft associated with the first rotating brush and in further communication with a second motor operatively coupled to a second shaft associated with the second rotating brush. The controller may be configured to return the first and second rotating brushes to a home position in which the first rotating brush is not in contact with the first porous member and the second rotating brush is not in contact with the second porous member. It is contemplated that the first rotating brush is mounted in a channel in the first shaft and the second rotating brush is mounted in a channel in the second shaft. It is also contemplated that a speed of rotation of each shaft is adjustable.

It is still further contemplated that the first and second rotating brushes have an adjustable height.

These and other aspects and embodiments of the present invention will be appreciated by those of ordinary skill in the art based upon the following description of the drawings and detailed description of the preferred embodiments.

### BRIEF DESCRIPTION OF THE DRAWINGS

The attached figures in the drawings will make it possible to understand how the invention can be produced. In these figures, similar reference numbers denote similar elements.

FIG. 1 is a front, elevational view of the present filtering device.

FIG. 2 is a right side, elevation view of the present filtering device of FIG. 1.

FIG. 3 is a top and left side perspective view of the present filtering device of FIG. 1 in which a portion of the housing has been removed.

FIG. 4 is a left side, elevation view of the present filtering device of FIG. 1 in which a portion of the housing has been removed.

### DETAILED DESCRIPTION OF THE PREFERRED EMBODIMENTS

As mentioned above, a new filtering device has been invented. In a preferred embodiment, the new filtering device pumps water out of a tunnel washer. This permits all the water to be filtered at least once. Inside of the filtering device, gravity is used to transport the water through porous members to clean the water. By using gravity, the porous members will not be as easily blinded, or clogged, as a result of pressure forcing the water through the screens. Additionally, by using gravity, the porous members can have a smaller mesh size—therefore removing more debris. If the filter device was under pressure, the porous members would clog quicker and the pressure would force the debris into the mesh making it harder to clean. As opposed to backwashing the porous members, according to the present invention, a rotating brush is utilized to clean the screens.

In view of the foregoing, at least one embodiment of the present invention will now be described with the understanding that the following description is not intended to be limiting.

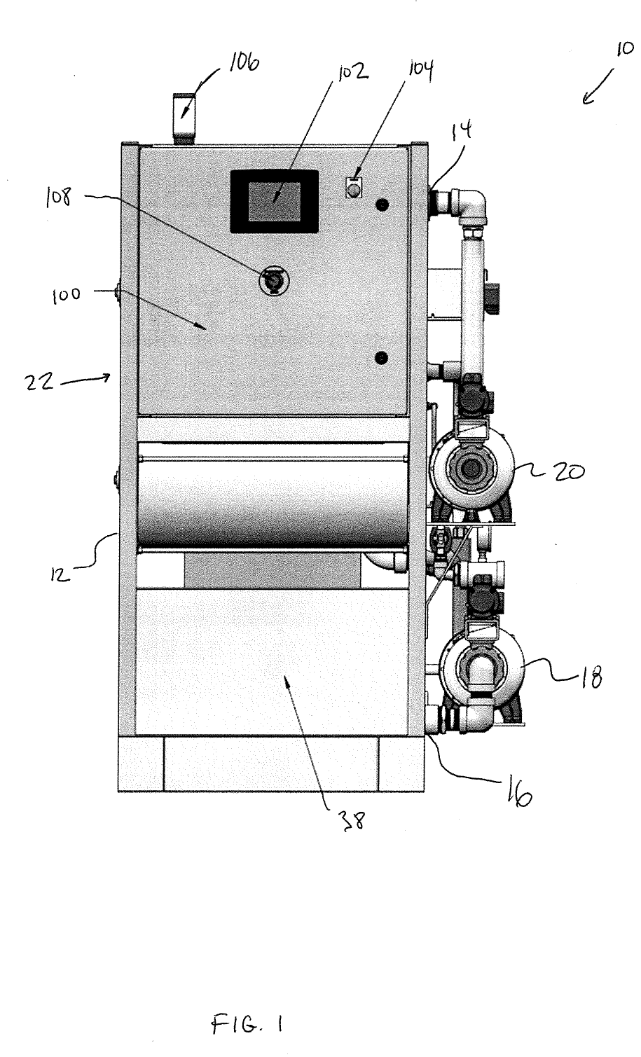

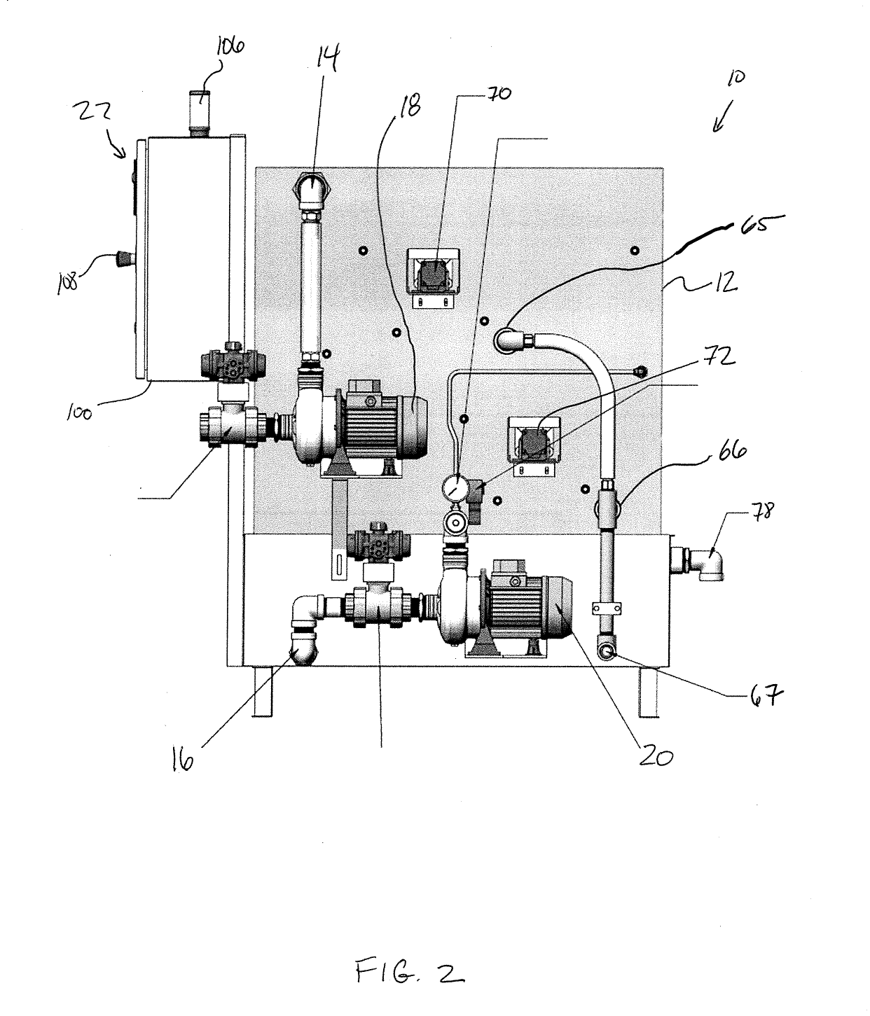

With reference to FIGS. 1 and 2, the new filtering device 10 is shown. Generally, the filtering device 10 includes a housing 12 which forms a body. An inlet 14, which is configured to receive soiled water comprising solids, is located at or near the top of the housing 12 and an outlet 16, which is configured to provide cleaned water, is located at or near the bottom of the housing 12. By “cleaned water” it is meant that the water at the outlet 16 has a lower solids content than the water at the inlet 14.

The filtering device 10 may include two pumps 18, 20. One of the pumps 18 is associated with the inlet 14, and the second pumps is associated with the outlet 16. The speed of the pumps 18, 20 may be controlled by level switches measuring a level of water in the device 10 to prevent too much water being removed or returned to the tunnel washer. The speeds of the pumps 18, 20 may be adjusted independently so as to provide adjustable flow rates on the incoming and outgoing water. Additionally, the speeds of the pumps 18, 20 can be adjusted based on the needed to remove the debris from the water and provide water back to the tunnel. A controller 22 may be provided to control the pumps 18, 20, as well as other aspects of the filtering device 10.

The controller 22 includes a housing 100 with a processor (not shown), memory (not shown), a display screen 102, and hardware (e.g., ports, interfaces, antennas, amplifiers, signal processors, etc.) for wired or wireless communication. The controller 22 may include software stored in a non-transitory medium, hardware, firmware, etc., containing executable instructions for causing various other elements of the filtering device 10, as discussed below, to perform one or more steps of example methods. Example software can include an operating system running one or more applications (apps) that perform one or more steps of example methods and display data or information as well as allowing a user to enter data or information. The display screen 102 may be a touch screen or other device for allowing a user to enter data or information. Additionally, a power indicator 104 light, an alarm indicator (audio, visual or both) 106, and an emergency shut off button 108 may be provided.

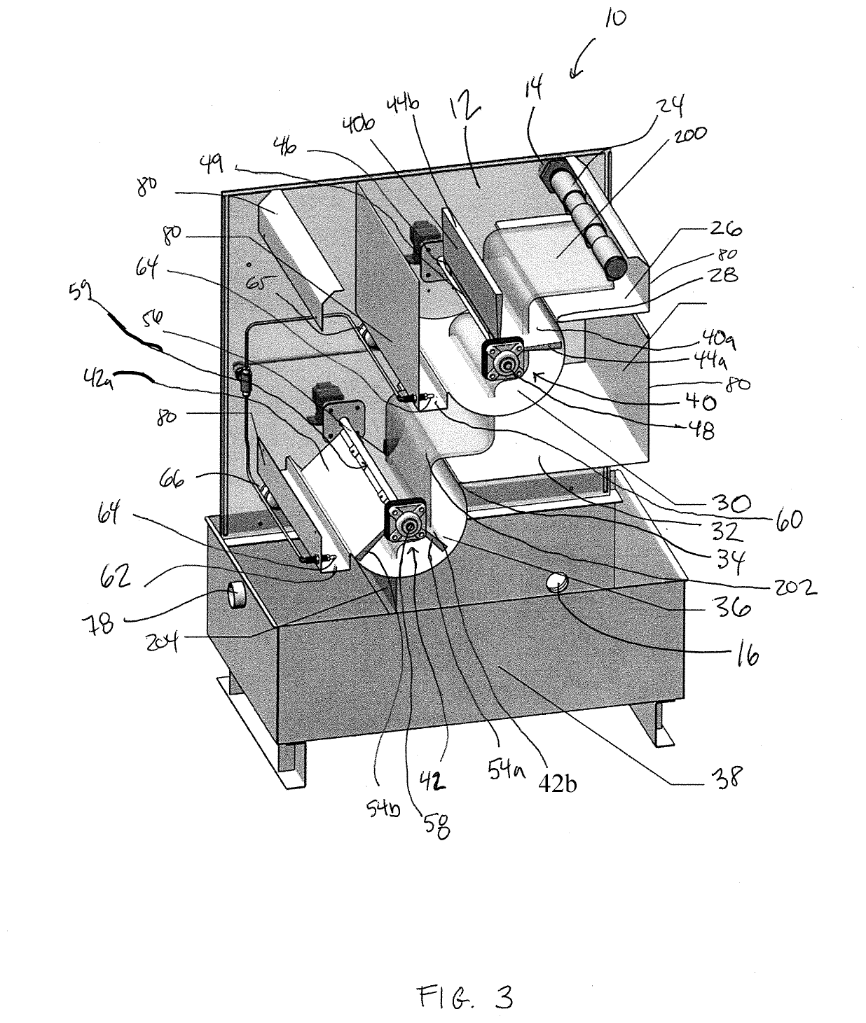

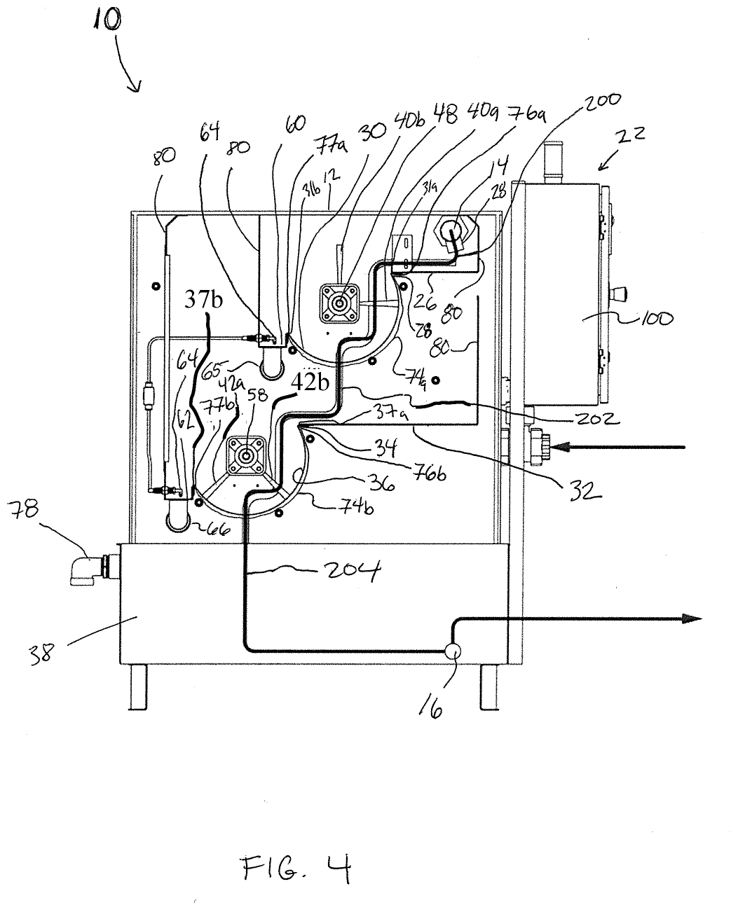

Turning to FIGS. 3 and 4, a dispenser 24 is associated with the inlet 14 and configured to dispense water onto a first plate 26 that has been removed from the tunnel by the pump 18 (see, FIGS. 1 and 2) and passed to the inlet 14. The first plate 26 allows the water to spread out across the plate 26, before flowing over a front edge 28 of the plate 26 and through a first porous member 30. By distributing the water over the first plate 26, the solids are also distributed more evenly when flowing into the first porous member 30.

The first porous member 30 may be a screen or other filter material that includes a plurality of pores, or openings, which allow water to flow therethrough, but which retain solids with a size larger than the size of the pores. The water that passes through the first porous member 30 flows onto a second plate 32.

The second plate 32 also allows the water to spread out across the second plate 32. The water will flow over a front edge 34 of the second plate 32 and through a second porous member 36 and is collected in reservoir 38. From the reservoir 38, cleaned water can be withdrawn by the pump 20 (see, FIGS. 1 and 2) through the outlet 16, and returned to the tunnel (not shown).

The second porous member 36, like the first porous member 30, may be a screen or other filter material that includes a plurality of pores, or openings, which allow water to flow therethrough, but which retain solids with a size larger than the size of the pores. Using multiple porous members 30, 36 allows the filtering device 10 to be customized for the application and the amount and type of debris to remove. Specifically, it is contemplated that the pores of the first porous member 30 are larger than the pores of the second porous member 36. Additionally, while the present embodiment of the filtering device 10 includes two plates 26, 32 and two porous members 30, 36, it is contemplated that additional (i.e., more than two) plates and porous members may be included in the filtering device 10.

As mentioned above, the purpose of the first and second porous members 30, 36 is to remove solids from the water flowing therethrough. Thus, the retained solids will accumulate on the first and second porous members 30, 36. According to the present invention, in order to clean the porous members 30, 36, each porous member is associated with a rotating brush 40, 42.

A first rotating brush 40 is associated with the first porous member 30. The first rotating brush 40 includes a first plurality of bristles 44a, forming a first brush 40a, arranged on a rotatable shaft 46. Preferably, the bristles 44a from the first plurality of bristles 44a are arranged in a line when viewed from an end 48 of the rotatable shaft 46. In a preferred embodiment, the first rotating brush 40 also includes a second plurality of bristles 44b, which includes bristles 44b, also arranged in a line to form a second brush 40b. The second brush 40b may be angularly offset, when viewed from the end 48 of the rotatable shaft 46, from the first brush 40 by 90 degrees.

The first brush 40a and the second brush 40b are preferably installed into channels 49 in the rotatable shaft 46. Furthermore, it is contemplated that a height of the brushes 40a, 40b is adjustable to ensure that the brushes 40a, 40b are in sufficient contact with the first porous member 30. Such a feature is particularly desirable to prolong the life of the brushes 40a, 40b as the brushes 40a, 40b may lose height due to their use.

The second rotating brush 42 is associated with the second porous member 36. The second rotating brush 42, in the depicted embodiment, has the same configuration as the first rotating brush 40, with first and second brushes 42a, 42b, each formed by bristles 54a, 54b. Again, both brushes 42a, 42b are preferably secured to a rotatable shaft 56 having and end 58 and channels 59 for the brushes 42a, 42b. Thus, the above description of the first rotating brush 40 and its components are incorporated herein by reference in regard to the second rotating brush 42 and its components.

Other configurations, angular displacement, shapes, numbers of brushes, etc. may be used. However, it is believed that at least two brushes 40a, 40b, 42a, 42b on each shaft 46, 56 are particularly beneficial because the first brushes 40a, 42a will remove most of the debris on the respective porous members 30, 36 but will also loosen that debris that is not removed. The second brushes 40b, 42b then remove the loosened debris from the respective porous members 30, 36.

As the shafts 46, 56 are rotated, the solids retained by the first and second porous members 30, 36 will be pushed by the brushes 40a, 40b, 42a, 42b. Accordingly, the device 10 preferably includes a first tray 60 configured to collect debris removed from the first porous member 30 by the first rotating brush 40 and a second tray 62 configured to collect debris removed from the second porous member 36 by the second rotating brush 42. A nozzle 64 is located at one end at each tray 60, 62. The nozzles 64 dispense water onto each of the trays 60, 62 to push the solids collected in the trays 60, 62 out of drain apertures 65, 66 on the other end of each tray 60, 62 so that the retained solids can be collected and disposed of from a main solid drain 67.

In order to control the rotation of the rotating brushes 40, 42, as shown in FIGS. 1 and 2, the controller 22 may be in communication with a first motor 70 operatively coupled to the first shaft 46 associated with the first rotating brush 40. The controller 22 is also in communication with a second motor 72 operatively coupled to the second shaft 56 associated with the second rotating brush 42. In this manner, the controller 22 can send signals to each of the motors 70, 72, for example, to begin rotating the shafts 46, 56 to begin a cleaning operation to remove solids debris from the porous members 30, 36, to stop rotation of the shafts 46, 56 when a cleaning cycle is done, or to adjust a speed of the rotation of the shafts 46,56. The controller 22 may be in communication with a sensor (not shown) which determines a processing condition that triggers the beginning of a cleaning operation. Additionally or alternatively, the controller 22 may include logic associated with a timer which determines when a cleaning cycle is begun.

When the cleaning cycle is stopped, the brushes 40, 42 are preferably returned to a home position in which the first and second rotating brushes 40, 42 are maintained out of contact with the first or second porous member 30, 36. It has been found that if the brushes 40, 42 are maintained in contact with the porous members 30, 36 when not cleaning, the bristles 44a, 44b, 54a, 54b would eventually no longer return to their original shape and lose contact with the porous members 30, 36. Accordingly, to increase the usable life of the brushes 40, 42 it is preferred that they are returned, automatically, to a home position.

Turning to FIG. 4, in order to provide sufficient structural support for the porous members 30, 36, each may be supported by another, thicker porous member which forms a support porous member 74a, 74b. Compared with the pores of the porous members 30, 36, the pores of the support porous members 74a, 74b are larger so that the water can easily flow therethrough.

With reference to the first porous member 30 and the first support porous member 74a, a first end 76a of the support porous member 74a, and a first end 31a of the first porous member 30 is secured to the edge 28 of the first plate 26. A second end 77a of the support porous member 74a, and a second end 31b of the first porous member 30 is secured to the first tray 60. Ends 76b, 77b of the second support porous member 74b and ends 37a, 37b of the second porous member 36 are similarly secured to the edge 34 of the second plate 32 and the second tray 62.

As shown in FIGS. 3 and 4, an overflow drain 78 may be provided in the reservoir 38. Accordingly, if the water level in the reservoir 38 exceeds a certain level, the water will flow out of the overflow drain 78.

Additionally, in order to minimize water from traveling in an undesired flow path, various splash guards 80 are provided within the housing 12. The splash guards 80 are generally vertical walls but may include portions that are angled. Additionally, the splash guards 80 may be integrally formed with, for example, the plates 26, 32, or the trays 60, 62, or they may be discrete components which may or may not be secured together.

In FIGS. 3 and 4, the flow of water within the housing 12 is shown. Specifically, soiled water 200 is passed into the device 10 via the inlet 14. The solids water spreads out on an upper surface of the first plate 26 which is generally planar and may have a slight angle downward in the direction of its front edge 28. As a result of gravity, the soiled water 200 flows over the edge 28 and through the first porous member 30. Solid material that is larger than the pores in the first porous member will be retained on the first porous member 30, while an intermediate water 202 (with some solid materials) will flow onto the second plate 32. After the intermediate water spreads out on the second plate 32, which may also be generally planar and may have a slight angle downward in the direction of its front edge 34, the intermediate water 202, under the force of gravity, will flow over the edge 34 through the second porous member 36. The second porous member 36 will retain solids that are larger than the pores therein. Thus, it is preferable, again, that the second porous member 36 have smaller pores than the first porous member 30. A cleaned water 204, flowing through the second porous member 36, is collected in the reservoir 38, from where it may be returned to its source (or used in any other manner), by being withdrawn from the device via the outlet 16.

As indicated above, at some point, it will become desirable to clean the porous members 30, 36 and remove the retained solids. Accordingly, the controller 22 may (automatically or otherwise) send a signal to the motors 70, 72 to rotate the shafts 46, 56. The rotation of the shafts 46, 56 may occur independently or at the same time. As discussed above, the brushes 40a, 40b, 42a, 42b will push the solids along the porous members 30, 36 and into the trays 60, 62 where the solids can be collected and removed from the device 10, via the main solids drain 67 by water from the nozzles 64.

Thus, the present filtering device 10 is believed to effectively and effectively remove solids from the water, allowing the water to be re-used. The removal of the solids is believed to occur with less downtime, allowing the filtering device 10 (and tunnel washer) to operate for longer periods of time. Finally, as indicated above, while it the present filtering device 10 was described in relation to a tunnel washer, it is believed that the filtering device 10 could be used in other fields of use in which solids are removed from water.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1. A filtering device comprising:
an inlet configured to receive soiled water comprising solids;
an outlet configured to provide clean water, the clean water having a reduced amount of solids compared with the soiled water;
a first plate configured to receive soiled water from the inlet and allow the soiled water to disperse over a surface of the first plate;
a first porous member comprising a plurality of openings for retaining solids from the soiled water to provide an intermediate water;
a second plate configured to receive intermediate water and allow the intermediate water to disperse over a surface of the second plate;
a second porous member comprising a plurality of openings for retaining solids from the intermediate water to provide the cleaned water;
a first rotating brush configured to remove solids retained by the first porous member; and,
a second rotating brush configured to remove solids retained by the second porous member.

2. The filtering device of claim 1, wherein at least one of the first or second rotating brushes comprises two brushes.

3. The filtering device of claim 1 wherein both the first and second rotating brushes comprise two brushes.

4. The filtering device of claim 1 wherein an average size of the openings on the first porous member is greater than an average size of the openings of the second porous member.

5. The filtering device of claim 1 wherein at least one of the first and second porous members is supported by a third porous member.

6. The filtering device of claim 1 wherein at least one of the first and second rotating brushes is configured to return to a home position in which the at least one of the first and second rotating brushes is not maintained in contact with the first and second porous member.

7. The filtering device of claim 1 further comprising:
a reservoir configured to collect the cleaned water from the second porous member.

8. The filtering device of claim 1 further comprising:
a first tray configured to collect debris removed from the first porous member by the first rotating brush; and,
a second tray configured to collect debris removed from the second porous member by the second rotating brush.

9. The filtering device of claim 1 wherein water flows from the first plate, through the first porous member, to the second plate, and from the second plate through second porous member by gravity.

10. The filtering device of claim 1 wherein at least one of the first and second rotating brushes has an adjustable height.

11. A filtering device configured to remove solid from soiled water, the filtering device comprising:
a first catch plate configured to disperse water over a surface of the first catch plate before flowing over an edge of the first catch plate;
a second catch plate configured to disperse water over a surface of the second catch plate before flowing over an edge of the second catch plate;
a reservoir configured to collect water;
a first porous member disposed between the first catch plate and the second catch plate, the first porous member comprising a plurality of openings for retaining solids;
a second porous member disposed between the second catch plate and the reservoir, the second porous member comprising a plurality of openings for retaining solids;
a first rotating brush configured to remove solids retained by the first porous member; and,
a second rotating brush configured to remove solids retained by the second porous member.

12. The filtering device of claim 11, wherein water flows from the first catch plate, through the first porous member, to the second catch plate by gravity.

13. The filtering device of claim 11, wherein the first and second rotating brushes each comprises two brushes.

14. The filter device of claim 13, wherein an average size of the openings on the first porous member is greater than an average size of the openings of the second porous member.

15. The filtering device of claim 11 further comprising:
a first tray configured to collect debris removed from the first porous member by the first rotating brush; and,
a second tray configured to collect debris removed from the second porous member by the second rotating brush.

16. The filtering device of claim 11, further comprising:
a controller, the controller in communication with a first motor operatively coupled to a first shaft associated with the first rotating brush, and the controller in further communication with a second motor operatively coupled to a second shaft associated with the second rotating brush.

17. The filtering device of claim 16, wherein the controller is configured to return the first and second rotating brushes to a home position in which the first rotating brush is not in contact with the first porous member and the second rotating brush is not in contact with the second porous member.

18. The filtering device of claim 16, wherein the first rotating brush is mounted in a channel in the first shaft and the second rotating brush is mounted in a channel in the second shaft.

19. The filtering device of claim 16, wherein a speed of rotation of each shaft is adjustable.

20. The filtering device of claim 11, wherein the first and second rotating brushes have an adjustable height.
